(19) United States
(12) Patent Application Publication
(10) Pub. No.: US 2007/0028112 A1
(43) Pub. Date: Feb. 1, 2007

(54) Data transfer device

(76) Inventors: John Mark Mackelden, Bristol (GB); Nigel Ronald Evans, Bristol (GB)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/482,556

(22) Filed: Jul. 6, 2006

(30) Foreign Application Priority Data
Jul. 29, 2005 (GB) 0515734.2

(51) Int. Cl. H04L 9/00

(52) U.S. Cl. 713/176

(57) ABSTRACT

A data transfer device for transferring data between a host device and a data storage medium. The data transfer device encrypts and/or decrypts data transferred between the host device and the data storage medium using an encryption/decryption key stored in memory. A data storage medium stores an encryption/decryption key and has at least one media recognition indicium, which identifies the data storage medium to the data transfer device as one storing an encryption/decryption key. The data transfer device copies the encryption/decryption key from the data storage medium to the memory.

### FIELD OF THE INVENTION

The present invention relates to a data transfer device for transferring data between a host device and a data storage medium, wherein data are encrypted or decrypted by the data transfer device.

### BACKGROUND OF THE INVENTION

Data backup is a valuable tool in safeguarding important data. Data are generally backed-up onto portable data storage media, such as tape cartridges or optical discs, such that the backup data may be stored at a different geographical location to the primary data.

By storing important data onto portable data storage media, security issues become a consideration. For example, a visitor to a site might easily pocket a tape cartridge storing large amounts of commercially sensitive data.

Many backup software packages provide the option of encrypting data prior to backup. A drawback with this approach, however, is that the same software package must be used in order to retrieve and decrypt the backup data. Accordingly, backup data cannot be recovered using other legitimate systems where the backup software is not provided.

### SUMMARY OF THE INVENTION

The present invention provides a data transfer device for transferring data between a host device and a data storage medium, the data transfer device comprising a memory and being operable to: copy an encryption key from a data storage medium to the memory; receive data from the host device; encrypt the data using the encryption key stored in the memory; and store the encrypted data on a data storage medium.

Preferably, the data transfer device is operable to store the encrypted data on a data storage medium different to that from which the encryption key is copied.

Advantageously, the data transfer device includes a media recognition sensor for sensing features on or in a data storage medium and for identifying the data storage medium as an encryption data storage medium storing an encryption key, and the data transfer device is operable to copy an encryption key from a data storage medium to the memory only when identified as an encryption data storage medium.

Conveniently, the memory is removable and the data transfer device comprises a port for removably receiving the memory.

Preferably, the data transfer device is further operable to receive an encryption key from the host device and to store the received encryption key in the memory.

Advantageously, the memory is erasable to erase the encryption key stored in the memory, and the data transfer device is operable to store the data unencrypted on the data storage medium if no encryption key is stored in the memory.

Conveniently, the data transfer device is further operable to: retrieve encrypted data from a data storage medium; decrypt the encrypted data using the encryption key stored in the memory; and deliver the decrypted data to the host device.

Preferably, the data transfer device is further operable to: copy a decryption key from a data storage medium to the memory; and decrypt the encrypted data using the decryption key stored in the memory.

Advantageously, the data transfer device is further operable to receive a decryption key from the host device and to store the received decryption key in the memory.

Conveniently, the memory is erasable to erase the decryption key stored in the memory, and the data transfer device is operable to deliver the encrypted data undecrypted to the host device if no decryption key is stored in the memory.

Preferably, the memory is erasable to erase the decryption key stored in the memory, and the data transfer device is operable to determine if data retrieved from the data storage medium are encrypted and to return an error to the host device if the retrieved data are encrypted and no decryption key is stored in the memory.

Advantageously, the data transfer device is operable to: apply at least one error control code to the data received from the host device prior to encryption; analyse the error control code of the decrypted data to determine whether the encrypted data retrieved from the data storage medium have been successfully decrypted; deliver the decrypted data to the host device if the encrypted data have been successfully decrypted; and deliver an error to the host device if the encrypted data have not been successfully decrypted.

Conveniently, the data transfer device is operable to: retrieve data from a data storage medium; determine if the retrieved data are encrypted; decrypt the retrieved data and deliver the decrypted data to the host device if the retrieved data are encrypted; and deliver the retrieved data to the host device if the retrieved data are not encrypted.

Preferably, the data transfer device is a tape drive.

Another aspect of the present invention provides a data transfer device for transferring data between a host device and a data storage medium, the data transfer device comprising: means for storing a key; means for copying an encryption key from a data storage medium to the means for storing a key; means for receiving data from the host device; means for encrypting the data using the encryption key stored in the means for storing a key; and means for storing the encrypted data on a data storage medium.

Preferably, the data transfer device comprises: means for sensing features on or in a data storage medium for identifying the data storage medium as an encryption data storage medium storing an encryption key, wherein the means for copying copies an encryption key from a data storage medium to the means for storing a key only when the means for sensing identifies the data storage medium as an encryption data storage medium.

A further aspect of the present invention provides a computer program product storing computer program code executable by a data transfer device, wherein the data transfer device comprises a memory and is operable to transfer data between a host device and a data storage medium, and the computer program code when executed causes the data transfer device to: copy an encryption key from a data storage medium to the memory; receive data from the host device; encrypt the data using the encryption key stored in the memory; and store the encrypted data on a data storage medium.

Preferably, the computer program code when executed additionally causes the data transfer device to: sense features on or in a data storage medium to identify the data storage medium as an encryption data storage medium storing an encryption key, wherein the encryption key is copied from a data storage medium to the memory only when the data storage medium is identified as an encryption data storage medium.

A still further aspect of the present invention provides a data storage medium storing at least one of an encryption key and a decryption key and having at least one media recognition indicium which may be sensed by a media recognition sensor of a data transfer device for identifying the data storage medium to the data transfer device as one storing at least one of an encryption key and a decryption key.

Preferably, the data storage medium is removable and/or portable.

Advantageously, the data storage medium is a tape cartridge.

### BRIEF DESCRIPTION OF THE DRAWINGS

In order that the present invention may be more readily understood, embodiments thereof will now be described, by way of example, with reference to the accompanying drawings, in which:

FIG. 1 is a schematic block diagram of a tape drive embodying the present invention;

FIG. 2 is a flow diagram illustrating a method performed by the tape drive of FIG. 1 when reading data from a tape cartridge;

FIG. 3 is a flow diagram illustrating a method performed by the tape drive of FIG. 1 when writing data to a tape cartridge; and

FIG. 4 is perspective view from below of an encryption/decryption tape cartridge embodying the present invention.

### DETAILED DESCRIPTION

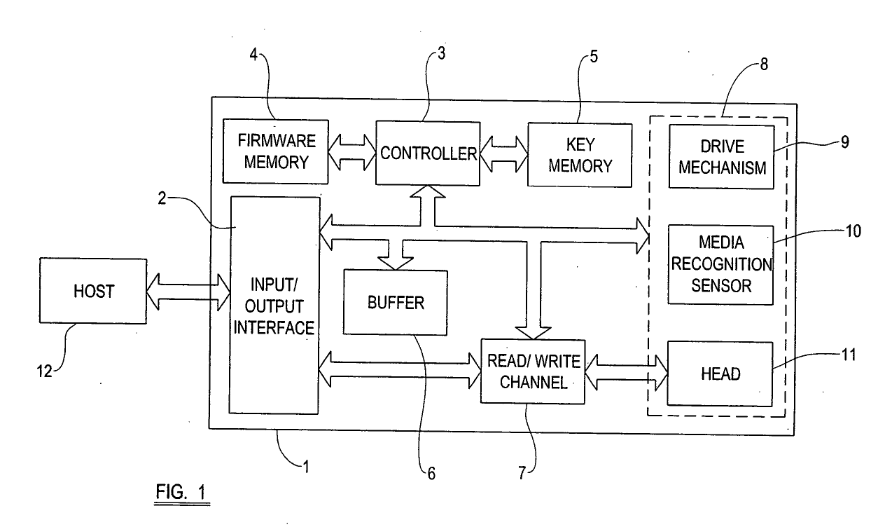

The tape drive 1 of FIG. 1 comprises an input/output interface 2, a controller 3, a first non-volatile memory 4, a second non-volatile memory 5, a memory buffer 6, a read/write channel 7, and a cartridge loader 8, which comprises a drive mechanism 9, a media recognition sensor 10 and a magnetic read/write head 11.

The input/output interface 2 controls the transfer of data between the tape drive 1 and a host device 12, such as a host computer. Control signals received from the host device 12 by the interface 2 are delivered to the controller 3, which, in response, controls the operation of the tape drive 1, i.e. the interface 2, read/write channel 7 and the cartridge loader 8.

The controller 3 comprises a microprocessor, which executes instructions stored in the first non-volatile memory 4. The instructions stored in the first non-volatile memory 4 are generally referred to as firmware and in order to better distinguish the first non-volatile memory 4 from the second non-volatile memory 5, the first non-volatile memory 4 shall hereafter be referred to as firmware memory 4.

The second non-volatile memory 5 stores an encryption key and/or a decryption key. As described in further detail below, the controller 3 uses the encryption key and/or decryption when reading data from and writing data to a tape cartridge. For the purposes of brevity, as well as to better distinguish the first and second non-volatile memories 4,5, the second non-volatile memory 5 shall hereafter be referred to as key memory 5.

The cartridge loader 8 is responsible for mounting and subsequently ejecting a tape cartridge onto which data are to be stored and retrieved. When a tape cartridge is inserted into the tape drive 1, the drive mechanism 9 winds the tape about a drum onto which the magnetic read/write head 11 is mounted. The drive mechanism 9 is also responsible for winding the tape forwards and backwards, as required. When the tape cartridge is inserted into the tape drive 1, the media recognition sensor 10 senses indicia on or in the tape cartridge (e.g. media identification holes formed on the casing of the tape cartridge) and, in response, outputs a signal to the controller 3 which then identifies the type and format of cartridge that has been inserted. It should be appreciated that the media recognition sensor 10 need not sense only physical features of the indicia as exemplified by the media identification holes but could also or alternatively sense and recognise the media by other mechanisms such as optically or electromagnetically, by, for example, a specially recorded magnetic pattern or a CIP code—a CIP code is a Cartridge Identifier Pattern, for example, a bar code on the start of the media optically read by the drive.

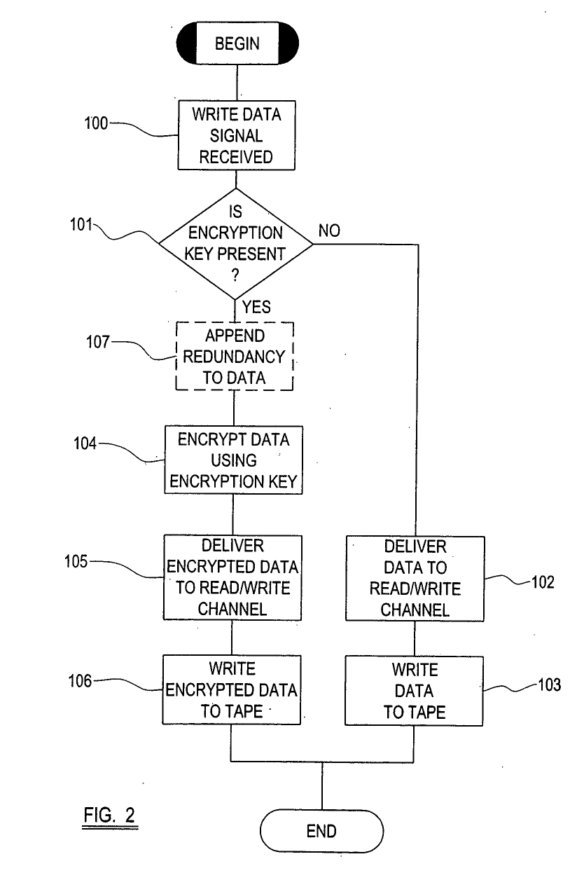

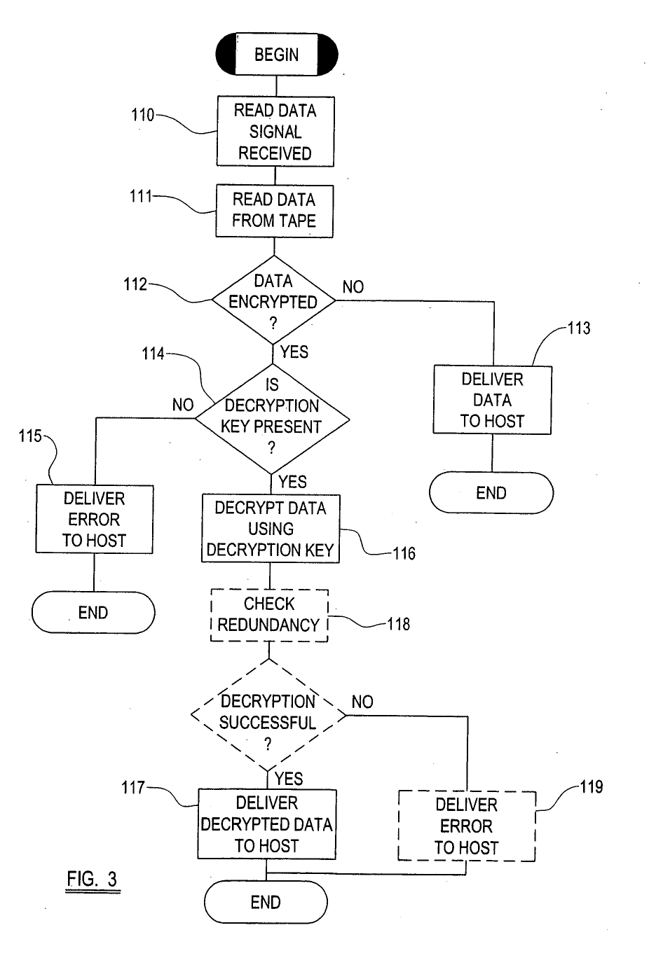

Operation of the tape drive 1, and in particular the controller 3 in executing the firmware instructions stored in firmware memory 4, will now be described with reference to FIGS. 2 and 3.

In response to receiving 100 a write data signal from the host device 12, the controller 3 determines 101 whether or not an encryption key is stored in the key memory 5. If no encryption key is stored, the data received from the host device 12 by the interface 2 are read 102 directly by the read-write channel 6. The read/write channel 6 then encodes the data and converts the encoded data into electrical signals suitable for driving 103 the magnetic read/write head 11. If, however, an encryption key is stored in key memory 5, the controller 3 encrypts 104 the data received from the host device 12 using the encryption key and stores the encrypted data in the memory buffer 6. Once encrypted, the read/write channel 3 reads 105 the encrypted data from the memory buffer 6, encodes the encrypted data and then converts the encoded, encrypted data into electrical signals suitable for driving 106 the magnetic read/write head 11.

The controller 3 applies error control coding by, for example, embedding or appending 107 redundancy data (e.g. checksum data) to the data received from the host device 12 prior to encryption. As detailed below, the inclusion of redundancy data enables the tape drive I to determine whether encrypted data later retrieved from a tape cartridge have been successfully decrypted.

In response to receiving a read data signal 110 from the host device 12, the controller 3 controls the cartridge loader 8, and in particular the drive mechanism 9, such that the tape is positioned over the magnetic read/write head 11 at the relevant position at which the requested data are stored. The tape is then wound forwards/backwards and the magnetic read/write head 11 reads 111 the data from the tape. The read/write channel 7 converts the resulting analogue signal received from the magnetic read/write head 11 into digital data, which are then decoded by the read/write channel 7 and stored in the memory buffer 6.

The controller 3 then determines 112 whether or not the data stored in the memory buffer 6 are encrypted. If the data are not encrypted, the data are delivered 113 to the host device 12 via the interface. If, however, the data are encrypted, the controller 3 determines 114 whether or not a decryption key is stored in the key memory 5. If no decryption key is stored, the controller 3 delivers 115 an error signal to the host device 12 via the interface 2 to indicate that the requested data are encrypted and that no decryption key could be found.

If a decryption key is stored in the key memory 5, the controller 3 decrypts 116 the encrypted data using the decryption key, stores the decrypted data in the memory buffer 6, and delivers 117 the decrypted data from the memory buffer 6 to the host device 12 via the interface 2.

As noted above, when writing data to a tape cartridge, the controller 3 embeds or appends 107 redundancy data to the data to be stored prior to encryption. In this preferred embodiment, when reading data from the tape cartridge, the controller 3 compares 118 the redundancy data of the decrypted data to that expected had the decryption process been successful. For example, where the redundancy data comprise cyclic redundancy checksum (CRC) data, the controller calculates the CRC data for the decrypted data and compares this against the actual CRC data that are embedded or appended to the decrypted data. If the redundancy data of the decrypted data correspond to that expected, the decrypted data (i.e. without the redundancy data) are delivered 117 from the memory buffer 6 to the host device 12 via the interface 2. If, however, the redundancy data of the decrypted data do not correspond to that expected, the controller 3 delivers 119 an error signal to the host device 12 via the interface 2 to indicate that the requested data could not be successfully decrypted. Unsuccessful decryption may arise because the wrong decryption key was used to decrypt the data and/or the encrypted data read from the tape cartridge were corrupt.

The encryption and decryption keys that are stored in the key memory 5 may be delivered to the tape drive 1 by the host device 12 via the input/output interface 2. In particular, the controller 3 may be operable to receive a control signal from the host 12 to store an encryption key or decryption key delivered by the host 12, or to delete an encryption key or decryption key stored in the key memory 5.

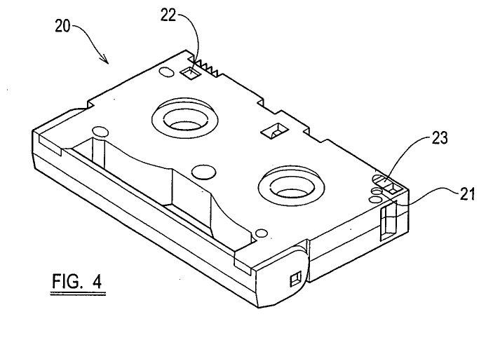

Alternatively or additionally, the encryption and decryption keys are delivered to the tape drive 1 by means of an encryption/decryption tape cartridge 20. As illustrated in FIG. 4, the encryption/decryption tape cartridge 20 has particular indicia, such as a particular arrangement of recognition holes 21 or reflective regions 22, that are discernible by the media recognition sensor 10 for identifying the cartridge 20 as an encryption/decryption cartridge 20.

The encryption/decryption cartridge 20 stores at least one encryption or decryption key, or at least one pair of an encryption key and its corresponding decryption key. The cartridge 20 may also store usage information, such as whether the encryption/decryption key stored thereon has previously been used, the date and time when the key was used etc., which is written to the cartridge 20 by the tape drive 1 upon usage.

Upon inserting the encryption/decryption cartridge 20 into the drive 1, the controller 3 identifies the cartridge 20 as an encryption/decryption cartridge by means of a signal delivered by the media recognition sensor 10. Encryption/decryption key data stored on the cartridge 20 are then read by the magnetic read/write head 11 and read/write channel 7 and stored in the key memory 5. Previous key data stored in the key memory 5 are overwritten. Once the key data have been read from the cartridge 20, the cartridge 20 is automatically ejected by the tape drive 1 to indicate that the key data have been successfully read.

Importantly, the tape drive 1 copies the encryption/decryption key data from the cartridge 20 to the key memory 5 without involving the host device 12. In particular, the encryption/decryption key data are not sent by the tape drive 1 to the host device 12. Consequently, the resources of the host device 12 are not unnecessarily consumed by receiving the encryption/decryption key data from the tape drive 1, appending the key data to a control signal, and delivering the control signal and key data to the tape drive 1. Additionally, by copying the encryption/decryption key data directly from the cartridge 20 to the key memory 5 without involving the host device 12, the encryption and decryption keys used by the tape drive 1 to encrypt and decrypt data may be set and changed without the need for a special command or control signal to be issued by the host device 1. Consequently, the tape drive 1 is able to encrypt and decrypt data using the commands and control signals of conventional peripheral interfaces (e.g. SCSI, PCI, IDE, EISA, USB, FireWire®, Bluetooth®, etc.). To this end, no modification in the behaviour of the host device 12 is required. Instead, the host device 12 communicates with the tape drive 1 in the same manner as that for a conventional tape drive. A further advantage of copying the encryption/decryption key data directly from the cartridge 20 to the key memory 5 is that there is no risk of the encryption/decryption key data being intercepted by a third party, e.g. by intercepting wireless or network data packets.

The tape drive 1 may include user input/output means (not shown) for providing a user with an indication of the status of the tape drive 1 and/or for providing the user with means to switch the tape drive 1 between an encryption/decryption mode and a normal mode, in which no encryption/decryption takes place. For example, the tape drive 1 may include one or more LEDs that are illuminated during use to indicate the status of the tape drive 1. For example, a particular LED may be illuminated to indicate that key data have been successfully read from an encryption/decryption cartridge 20. Additionally, different coloured LEDs may be used to indicate whether data being stored to or retrieved from a tape cartridge are encrypted or unencrypted.

The tape drive 1 may additionally include a button which when depressed causes the contents of the key memory 5 to be erased. In this manner, a user can quickly switch the tape drive 1 from an encryption/decryption mode to a normal mode. Alternatively, or additionally, the tape drive 1 may include a switch that is switchable between two positions to cause the tape drive 1 to operate in either an encryption/decryption mode or a normal mode. When the position of the switch indicates encryption/decryption mode, the tape drive 1 behaves as described above. When the position of the switch indicates normal mode, the controller 3 is caused to ignores the contents of the key memory 5 and to proceed as if no key data were stored in the key memory 5.

The tape drive 1 may alternatively or additionally communicate with the host device 12 for providing a user with an indication of the status of the tape drive 1 and/or for providing the user with means to switch the tape drive 1 between an encryption/decryption mode and a normal mode. For example, the controller 3 may deliver a message signal to the host device 12 to indicate that key data has been successfully read from the encryption/decryption cartridge 20. Additionally, the controller 3 may request confirmation from the host device 12 that key data already stored in the key memory 5 are to be overwritten, or to confirm which key data stored on an encryption/decryption cartridge 20 are to be retrieved (e.g. encryption key, decryption key or both). The controller 3 may also be operable to receive a request from the host device 12 to delete key data stored in the key memory 5, so as to switch from an encryption/decryption mode to a normal mode. Alternatively, or additionally, the controller 3 may be operable to receive a request from the host device 12 to ignore key data stored in the key memory 5; this may be achieved, for example, by storing flag data in the key memory 5 that notifies the controller that key data are to be ignored.

Key data stored in the key memory 5 may alternatively be erased by means a key-eraser cartridge (not shown). The key-eraser cartridge, like that of the encryption/decryption cartridge 20, includes indicia on or in the cartridge that are recognisable by the media recognition sensor 10. Accordingly, when the key-eraser cartridge is inserted into the tape drive 1, the controller 3 (by means of the media recognition sensor 10) recognises the cartridge as a key-eraser cartridge and in response deletes the contents of the key memory 5. The key-eraser cartridge is therefore used to switch the mode of the tape drive 1 from encryption/decryption to normal.

The encryption/decryption cartridge 20 may serve as a key-eraser cartridge by including user-changeable media recognition indicia 23 (e.g. a slideable tab portion). Upon changing the arrangement of the user-changeable media recognition indicia 23 (e.g. by sliding the slideable tab portion), the cartridge 20 is recognised by the media recognition sensor 10 as a key-eraser cartridge rather than an encryption/decryption cartridge.

In large-scale systems, in which the backup of data is performed by a plurality of tape drives 1, the same encryption/decryption cartridge 20 may be used with each of the plurality of tape drive 1 such that all backup data are encrypted (or decrypted) using the same encryption key (or decryption key). Additionally, should a tape drive 1 need to be replaced, the replacement tape drive may be programmed with the same encryption and/or decryption key as that of the former tape drive 1 through the use of the same encryption/decryption cartridge 20.

Whilst reference has thus far been made to an encryption key and a separate decryption key, it should of course be appreciated that for symmetric encryption the same key is used for both the encryption key and decryption. Consequently, where the tape drive 1 employs a symmetric encryption algorithm, only a single key need by stored in the key memory 5 or on the encryption/decryption cartridge 20. Asymmetric encryption, however, has an advantage that the tape drive 1 may be configured to permit encryption only. Consequently, the tape drive 1 cannot be used by unauthorised persons to decrypt stored data.

In the embodiments described above, the firmware (i.e. the instructions to be executed by the controller 3) and the key data are stored in two separate non-volatile memories 4,5. It will, however, be appreciated that both the firmware and the key data may be stored in a single, partitioned non-volatile memory.

Alternatively, the key memory 5 may be removable from the tape drive 1. In particular, the key memory 5 may comprise a removable programmable memory device, such as a USB memory device or other flash memory device. Accordingly, rather than using an encryption/decryption cartridge 20 to write encryption/decryption key data to the key memory 5, the key memory 5 may be removed from the tape drive 1 and key data written to or deleted from the key memory 5 by means of a suitable writer. For example, where the key memory 5 comprises a USB memory device, the key memory 5 may be inserted into the USB slot of a computer and encryption/decryption key data written to or deleted from the key memory 5 by the computer.

Although embodiments of the present invention have been described with reference to a tape drive 1 and an encryption/decryption tape cartridge 20, it will be appreciated that aspects of the invention are relevant to other types of data transfer devices, such as optical drives, as well as to other types of portable data storage media, e.g. optical discs (e.g. CD, DVD).

With the data transfer device embodying the present invention, the encryption and decryption of backup data is moved from the host device to the data transfer device. The data transfer device does not rely upon special commands or control signals in order to encrypt or decrypt data, but instead encrypts and decrypts data in response to conventional read and write commands received from the host device. Accordingly, the data transfer device is capable of operating using standard hardware interfaces such as SCSI, PCI, IDE, EISA, USB, FireWire®, Bluetooth®, IrDA etc. By moving the encryption/decryption process to the data transfer device, data from a host device may be stored on a portable data storage medium and later retrieved by a different host device having a different operating system and/or backup software. Moreover, the data transfer device enables backup data to be encrypted/decrypted by host devices having software that does not provide for data encryption/decryption.

When used in this specification and claims, the terms “comprises” and “comprising” and variations thereof mean that the specified features, steps or integers are included. The terms are not to be interpreted to exclude the presence of other features, steps or components.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilised for realising the invention in diverse forms thereof.

1. A data transfer device for transferring data between a host device and a data storage medium, the data transfer device comprising a memory and being operable to:
copy an encryption key from a data storage medium to the memory;
receive data from the host device;
encrypt the data using the encryption key stored in the memory; and
store the encrypted data on a data storage medium.

2. A data transfer device according to claim 1, wherein the data transfer device is operable to store the encrypted data on a data storage medium different to that from which the encryption key is copied.

3. A data transfer device according to claim 1, wherein the data transfer device includes a media recognition sensor for sensing features on or in a data storage medium and for identifying the data storage medium as an encryption data storage medium storing an encryption key, and the data transfer device is operable to copy an encryption key from a data storage medium to the memory only when identified as an encryption data storage medium.

4. A data transfer device according to claim 1, wherein the memory is removable and the data transfer device comprises a port for removably receiving the memory.

5. A data transfer device according to claim 1, wherein the data transfer device is further operable to receive an encryption key from the host device and to store the received encryption key in the memory.

6. A data transfer device according to claim 1, wherein the memory is erasable to erase the encryption key stored in the memory, and the data transfer device is operable to store the data unencrypted on the data storage medium if no encryption key is stored in the memory.

7. A data transfer device according to claim 1, wherein the data transfer device is further operable to:
retrieve encrypted data from a data storage medium;
decrypt the encrypted data using the encryption key stored in the memory; and
deliver the decrypted data to the host device.

8. A data transfer device according to claim 7, wherein the data transfer device is further operable to:
copy a decryption key from a data storage medium to the memory; and
decrypt the encrypted data using the decryption key stored in the memory.

9. A data transfer device according to claim 7, wherein the data transfer device is further operable to receive a decryption key from the host device and to store the received decryption key in the memory.

10. A data transfer device according to claim 8, wherein the memory is erasable to erase the decryption key stored in the memory, and the data transfer device is operable to deliver the encrypted data undecrypted to the host device if no decryption key is stored in the memory.

11. A data transfer device according to claim 8, wherein the memory is erasable to erase the decryption key stored in the memory, and the data transfer device is operable to determine if data retrieved from the data storage medium are encrypted and to return an error to the host device if the retrieved data are encrypted and no decryption key is stored in the memory.

12. A data transfer device according to claim 7, wherein the data transfer device is operable to:
apply at least one error control code to the data received from the host device prior to encryption;
analyse the error control code of the decrypted data to determine whether the encrypted data retrieved from the data storage medium have been successfully decrypted;
deliver the decrypted data to the host device if the encrypted data have been successfully decrypted; and
deliver an error to the host device if the encrypted data have not been successfully decrypted.

13. A data transfer device according to claim 1, wherein the data transfer device is operable to:
retrieve data from a data storage medium;
determine if the retrieved data are encrypted;
decrypt the retrieved data and deliver the decrypted data to the host device if the retrieved data are encrypted; and
deliver the retrieved data to the host device if the retrieved data are not encrypted.

14. A data transfer device according to claim 1, wherein the data transfer device is a tape drive.

15. A computer program product storing computer program code executable by a data transfer device, wherein the data transfer device comprises a memory and is operable to transfer data between a host device and a data storage medium, and the computer program code when executed causes the data transfer device to:
copy an encryption key from a data storage medium to the memory;
receive data from the host device;
encrypt the data using the encryption key stored in the memory; and
store the encrypted data on a data storage medium.

16. A computer program product according to claim 15, wherein the computer program code when executed additionally causes the data transfer device to:
sense features on or in a data storage medium to identify the data storage medium as an encryption data storage medium storing an encryption key,
wherein the encryption key is copied from a data storage medium to the memory only when the data storage medium is identified as an encryption data storage medium.

17. A data storage medium storing at least one of an encryption key and a decryption key and having at least one media recognition indicium which may be sensed by a media recognition sensor of a data transfer device for identifying the data storage medium to the data transfer device as one storing at least one of an encryption key and a decryption key.

18. A data storage medium according to claim 17, wherein the data storage medium is portable.

19. A data storage medium according to claim 17, wherein the data storage medium is a tape cartridge.
